(19) United States
(12) Patent Application Publication
(10) Pub. No.: US 2005/0083786 A1
(43) Pub. Date: Apr. 21, 2005

(54) Multi-functional timer

(76) Inventor: Shih-Cheng Tsai, Tucheng City (TW)

Correspondence Address: BRUCE H. TROXELL, SUITE 1404, 5205 LEESBURG PIKE, FALLS CHURCH, VA, 22041, US

(21) Appl. No.: 10/684,678

(22) Filed: Oct. 15, 2003

(51) Int. Cl. G04B 19/24; G04C 17/00

(52) U.S. Cl. 368/30

(57) ABSTRACT

A multi-functional timer comprises a CPU connected respectively with a setting unit, display unit, output control circuit and oscillating circuit. The setting unit has several switches; the switches are connected to several buttons on a panel. The display unit has a display zone, setting date display zone and date/time display zone. Digits 1 to 7, which represent Monday to Sunday, can be shown at the setting date display zone. The display zone is also combined onto the panel. The timer according to the present can be simpler on the setting operation of a work time and can be used to set different work time sections as well as to set every kind of action interval in a work time section.

### BACKGROUND OF THE INVENTION

1. Field of the Invention

The present invention relates to a timer, and more particularly to a multi-functional timer for controlling the time that fragrance fluid is sprayed out of an air freshener dispenser.

2. Description of Related Art

A general air freshener dispenser is usually placed in a toilet for a user to press a spray control arm thereof manually to spray out fragrance to eliminate odor and to release fragrance in the toilet. Especially, the manual control way to spray fragrance fluid is labor and time waste for an air freshener dispenser that is located in each one of a large amount of toilets located in every area or every floor of a large public place such as department store, amusement park, airport or office. For resolving the problem mentioned above, the inventor of the present invention propose a multi-functional timer combined with an air freshener dispenser to spray fragrance according to a preset time section and spray time interval so as to save labor and time substantially and to maintain the fragrance in a toilet effectively and automatically.

Taiwan patent No. 382,481 discloses a multiple display device with a timer comprising a multiple LCD screen capable of showing digits and indicator. The digit screen has a time screen, state screen and week screen. And, a plurality of timer display zones are disposed around on the indicator screen. The setting display zones are partly caused to be black and light up, an electromagnetic switch is caused to start and further to communicate the AC power supply thereon with an output socket to start the timer while setting the timer.

Although a start time can be set in the patent mentioned above to attain timer-started function, but multi-sections and multi-spray-time-intervals cannot be set according to a use date and time. For example, the setting that fragrance is sprayed every hour from 8 a.m. to 6 p.m. every day from Monday to Friday cannot be set to maintain fresh air in working hours. The present invention is brought out to provide a multi-functional timer used in an air freshener dispenser.

### SUMMARY OF THE INVENTION

The main object of the present invention is to provide a multi-functional timer capable of processing every kind of time setting by taking a week as a unit.

### BRIEF DESCRIPTION OF THE DRAWINGS

The present invention can be more fully understood by reference to the following description and accompanying drawings, in which:

FIG. 1 is a diagram showing a circuit according to the present invention;

FIG, 2 is a schematic view showing a control panel according to the present invention; and

FIG. 3 is a schematic view showing the disposition of units according to the present invention.

### DETAILED DESCRIPTION OF THE PREFERRED EMBODIMENTS

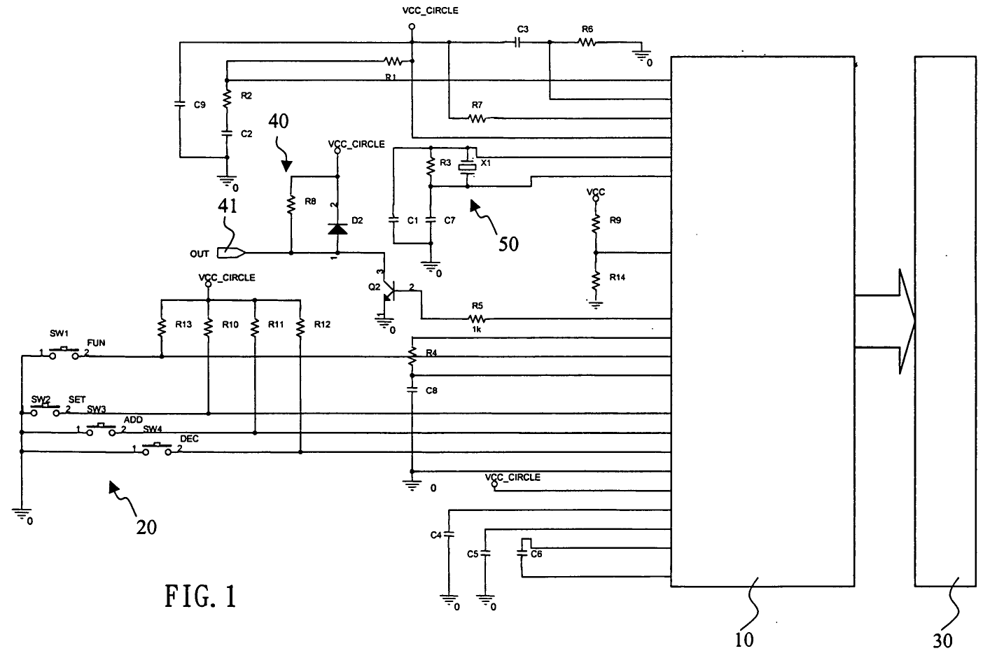

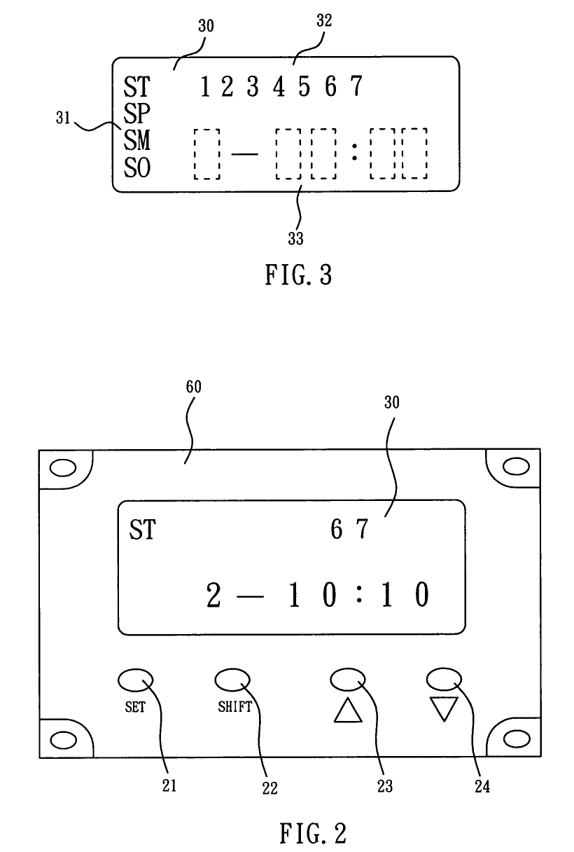

Please refer to FIG. 1. A multi-functional timer comprises a CPU 10 connected respectively with a setting unit 20, display unit 30, output control circuit 40 and oscillating circuit 50. The setting unit 20 has four switches, which are connected respectively to a confirmation button 21, movement button 22, up-adjustment button 23 and down-adjustment button 24 on a panel 60 shown in FIG. 2 for a user to use the buttons to control the settings in the CPU 10. The display unit 30 can be a LCD; it can display the timer control messages controlled by the CPU 10. Please refer to FIG. 3. The display unit 30 has a setting display zone 31, date setting display zone 32 and date/time display zone 33. The display zone 31 can display symbols such as “ST”, “SP”, “SM” and “SO”. The “ST” represents work-starting time setting, the “SP” represents work-stopping time setting, the “SM” represents how-many-minutes-acts-once setting or work-day-in-one-week setting, and “SO” represents output-time setting. Digits such as 1 to 7, which represents Monday to Sunday, can be shown in the date setting display zone 32. Weekday, hour and minute can be shown in the date/time display zone 33. The display unit 30 can also be disposed on the panel 60 to show a setting operation state and setting state. The output control circuit 40 has an output end 41 connected to a controller so as to allow the CPU to control the controller to act according to the setting date, time and work time interval. The control can be a relay, electromagnetic switch and etc. The oscillating circuit 50 provides oscillating signals needed for the CPU 10.

The confirmation button 21, movement button 22, up-adjustment button 23 and down-adjustment button 24 are used in the present invention to set a current time, everyday's work time interval, how long works once and how many days do not work in one week. The setting way of the present invention is described as the following:

1. Current Time Setting:

Use the up-adjustment button 23 and/or the down-adjustment button 24 to select the function “SO” under a general time display mode. Set “Time” after the confirmation button 21 is pressed down, use the up-adjustment button 23 and/or down-adjustment button 24 to input the current time (1 to 24 o'clock ). Press the movement button 22 down to set “Minute” after the correct input is confirmed, use the up-adjustment button 23 and/or the down-adjustment button 24 to input the current time (0 to 60 minutes). Press the movement button 22 to set “Weekday” after the correct input is confirmed, use the up-adjustment 23 and/or the down-adjustment button 24 to input current date (Monday to Sunday). Press the confirmation button 21 down after the correct input is confirmed to end the current time setting.

2. Everyday's Working Interval Setting:

Use the up-adjustment button 23 and/or the down-adjustment button 24 to select the “ST” function under a general time display mode. Set “Time” after the confirmation button 21 is pressed down, use the up-adjustment button 23 and/or down-adjustment button 24 to input the work starting time (1 to 24 o'clock). Press the movement button 22 down to set “Minute” after the correct input is confirmed, use the up-adjustment button 23 and/or the down-adjustment button 24 to input the work starting time (0 to 60 minutes). Press the confirmation button 21 down after the correct input is confirmed to end the work starting time setting. Use the up-adjustment button 23 and/or the down-adjustment button 24 to select the “SP” function under a general time display mode. Set “Time” after the confirmation button 21 is pressed down, use the up-adjustment button 23 and/or the down-adjustment button 24 to input the work stopping time (1 to 24 o'clock). Press the movement button 22 down to set “Minute” after the correct input is confirmed, use the up-adjustment button 23 and/or the down-adjustment button 24 to input the work stopping time (0 to 60 minutes). Press the confirmation button 21 down after the correct input is confirmed to end the work stopping time setting and so to end the everyday's working interval setting.

3. How-Long-Acts-Once Setting:

Use the up-adjustment button 23 and/or the down-adjustment button 24 to select the “SM” function under a general time display mode. Set “Minute” after the confirmation button 21 is pressed down. Use the up-adjustment button 23 and/or the down-adjustment button 24 to input a how-long-acts-once interval (0 to 99 minutes). Press the confirmation button 21 down after the correct input is confirmed to end the how-long-acts-once setting. The spray action is incessant to the end of the work when an interval “0 minute” is input.

4. No-Work-Day-In-One-Week Setting

use the up-adjustment button 23 and/or the down-adjustment button 24 to select the “SM” function under a general time display mode. Press the movement button 22 to set “Weekday” after the confirmation button 21 is pressed down. Use the up-adjustment button 23 and/or the down-adjustment button 24 to input a current rest date (Monday to Sunday). Press the confirmation button 21 down after the correct input is confirmed. The action mentioned above is repeated if there is another rest date. Consequently, the dates that the spray work is not practiced in a week are shown on the display unit.

The setting mode taking a week as a circulation unit in the present invention conforms with the a general person work mode that takes a week as a circulation unit so that it is easy to set a working time in a week. It does not operate like a general timer that takes a day as a circulation unit and needs to set a work time everyday or to adjust the work time when it is Saturday or Sunday.

The work time setting operation of the timer according to the present invention is much easier and many different work intervals and different action intervals in a work time can be set. For example, the air freshener dispenser according to the present invention can be set to spray once every 90 minutes (or other intervals) form 8 a.m. to 6 p.m. everyday on Monday to Friday every week and rests on Saturday and Sunday. Therefore, the spray work can be operated in coordination with a general work hour and conforms to a practical need. A general timer cannot compete with the timer according to the present invention. The timer according to the present invention can be used for timer setting in other devices such as an automatic fish feeder.

It is noted that the fast assembly structure module described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A multi-functional timer, comprising a CPU connected with a setting unit, display unit, output control circuit and oscillating circuit; said setting unit has switches, said switches being connected to buttons on a panel, whereby a user can use said buttons to control settings of said CPU; said display unit has a setting display zone, setting date display zone and date/time display zone; all or a part of digits 1 to 7, which represent Monday to Sunday, being able shown at said setting date display zone; said display unit also being combined to said panel, whereby a setting operation state and setting state can be shown; said output control circuit has an output end so as to be connected to a controller to allow said controller to be controlled by said CPU to practice an action according to a set date, time and action interval; said oscillating circuit provide oscillating signals need by said CPU.

2. The timer according to claim 1, wherein said display zone has symbols showing a work-starting time setting, work-stopping time setting, how-many-minutes-acts-once setting or work-day-in-one-week setting, and output time setting.

3. The timer according to claim 1, wherein said setting unit comprised four switches respectively connected to a confirmation button, movement button, up-adjustment button and down-adjustment button on said panel.

4. The timer according to claim 2, wherein said setting unit comprised four switches respectively connected to a confirmation button, movement button, up-adjustment button and down-adjustment button on said panel.

5. The timer according to claim 3, wherein a weekday, time and minute can be shown in said date/time display zone.

6. The timer according to claim 4, wherein a weekday, time and minute can be shown in said date/time display zone.

7. The timer according to claim 5, wherein said display unit is a LCD.

8. The timer according to claim 6, wherein said display unit is a LCD.
